(19) United States
(12) Patent Application Publication
(10) Pub. No.: US 2016/0112830 A1
(43) Pub. Date: Apr. 21, 2016

(54) Method and Apparatus for Detecting Smartphone Application Users Utilizing Globally Unique Identifiers and Wireless Sensors

(71) Applicant: Yee Ming Soon, Williamstown VIC (AU)

(72) Inventor: Yee Ming Soon, Williamstown VIC (AU)

(73) Assignee: Kakku Pty Ltd., Williamstown VIC (AU)

(21) Appl. No.: 14/516,486

(22) Filed: Oct. 16, 2014

(51) Int. Cl. H04W 4/02; H04W 4/00

(52) U.S. Cl. CPC H04W 4/02; H04W 4/008; H04W 84/12

(57) ABSTRACT

A method capable of detecting a location and activities of smartphone application users by combining the use of Globally Unique Identifiers (GUID) and various physical sensor infrastructure technologies. GUID (or UUID) is also known as ‘Globally Unique Identifier’ or ‘Universally Unique Identifier’ which uses a 128-bit integer number to identify resources. The physical sensor infrastructure technology includes WiFi, iBeacon and/or Near Field Communications.

### FIELD

The present invention relates to mobile applications and mobile internetworking. More particularly, the present invention relates to detecting a smartphone application through the use of Globally Unique Identifiers, in combination with underlying wireless sensor infrastructure.

### BACKGROUND

The exemplary mechanisms described herein are approaches that could be pursued, but not necessarily approaches that have been previously conceived or pursued. Therefore, unless otherwise indicated, the approaches described herein are not prior art to the claims in this or a subsequent application claiming priority to this application and are not admitted to be prior art by inclusion herein.

There are many use cases in the market that call for the need to perform accurate location base detection of smartphones, such uses cases are not limited to the following examples:
Location based shopping
Auto-issuance of loyalty points and stamps by physically entering a store
Automatic Check-in and Automatic Queuing mechanism base on user detection
Attracting consumers on mobile to enter a shop
Locating user relative to an indoor map

To facilitate this detection, there are many technologies currently available in the market that provides means for such detection and tracking. The technologies used to detect a smartphones location include but not limited to:
GPS
Bluetooth variants
Near Field Communications
WiFi

However most implementations today approach these location detection technologies from a competitive, contrasting or at best, disparate positions. For the objective to enhance intelligent mobile-to-environment experience, underlying technologies need to complement each other to serve the purpose of a common application.

This invention overcomes a number of such shortfalls and through implementation of this invention facilitates an environment to facilitate the intelligent mobile-to-environment interaction experience.

### SUMMARY

Kakku has invented a methodology to detect the location and activities of smartphone application users by combining the use of Globally Unique Identifiers (GUID) and various physical sensor infrastructure technologies. GUID (or UUID) is an acronym for ‘Globally Unique Identifier’ or (‘Universally Unique Identifier’). It is a 128-bit integer number used to identify resources.

There are many use cases in the market that call for the need to perform accurate location base detection of smartphones. There are many technologies currently available in the market that provides means for such detection and tracking.

The technologies used to detect a smartphones location include but not limited to:
GPS
Bluetooth variants, including Bluetooth low energy and iBeacon
Non-audible sonic pattern
Near Field Communications (NFC)
WiFi
Macro-cellular network triangulation (3G/4G)

This invention utilizes WiFi, iBeacon and NFC technologies to perform the detection of location and activity for smartphone applications, and its users. During the process of such detection, a single constant identifier—the GUID, is used as the anchor, uniquely identifying the Mobile Application on the user smartphone:
GUID is unique to the Mobile Application on a user smartphone that supports the logic stated in this invention
If there are multiple Mobile Applications on the same smartphone that supports the logic stated in this invention, there will be multiple corresponding GUID's attached to each of the Mobile Applications
GUID to Mobile Application effective association will cease once the Mobile Application is uninstalled from the smartphone.
New GUID is regenerated and re-associated on the smartphone should the same Mobile Application is being reinstalled on the user smartphone.

The objective and result of this invention is to:
a. Detect mobile application user locations and activities using a multitude of sensor infrastructure technologies, e.g. WiFi, iBeacon and NFC. Where the sensor network infrastructure maybe provided by a single infrastructure service provider, or a combination of multiple infrastructure service providers
b. Application Providers share and track only one abstracted identifier for each of their mobile application user
c. To accurately, near-real-time, detect location of an application user, when the smartphone is screen-off, idle state. E.g. no active application launch is required.
d. To utilize location information to perform application intelligent actions and policies upon the user
e. To produce analytical information about the historical locations and activities of the mobile application user
f. Creates no impact, or minimal impact on existing smartphone users behavior.

This invention achieves the objectives with collaboration amongst: Mobile Application, Sensor Network Infrastructure, Location Server and Application Server.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention. In the drawings:

FIG. 1 is the Overall System diagram, depicting the major system components and the communication flow/sequence between the individual system components in accordance with one embodiment of the present invention;

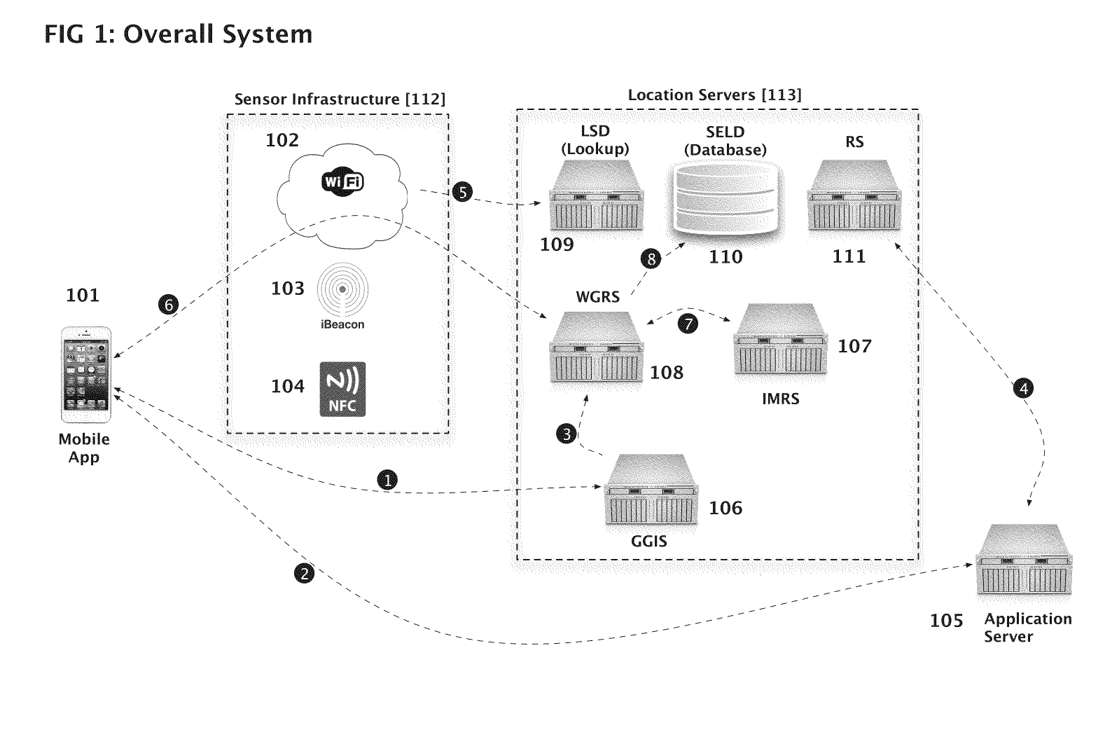

FIG. 2 is the Mobile App logic flow diagram in the context of WiFi detection in accordance with one embodiment of the present invention;

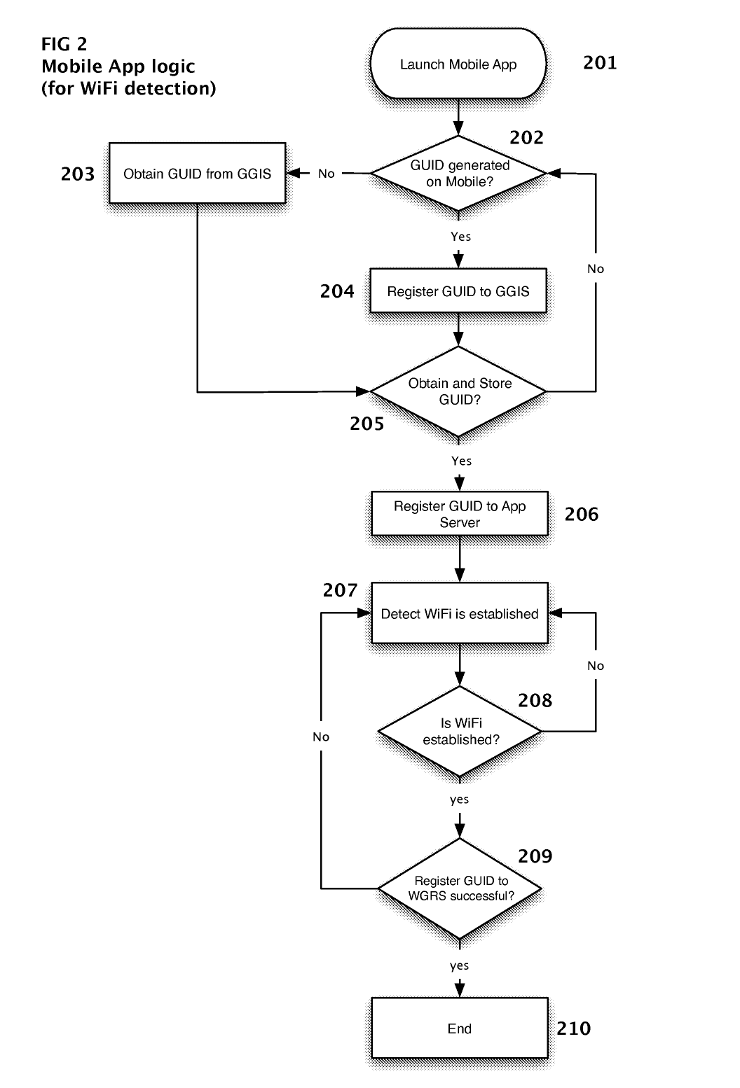

FIG. 3 is the GGIS logic flow diagram in the context of WiFi detection in accordance with one embodiment of the present invention;

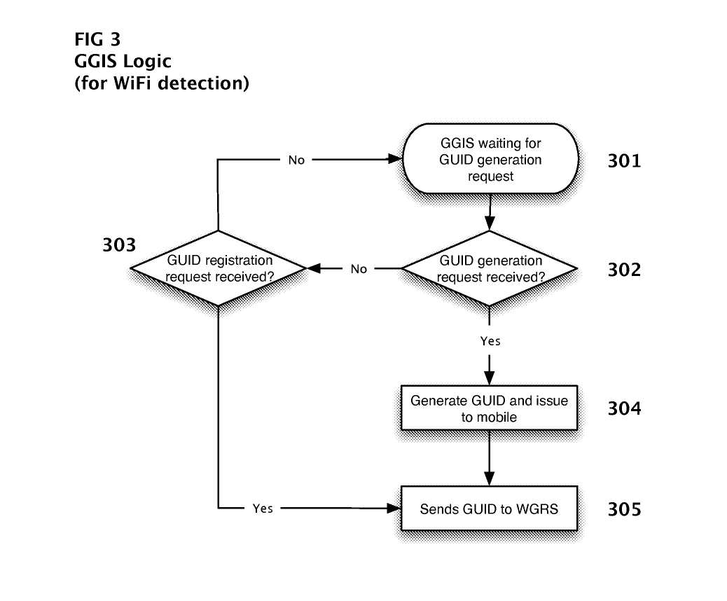

FIG. 4 is the IMRS logic flow diagram in the context of WiFi detection in accordance with one embodiment of the present invention;

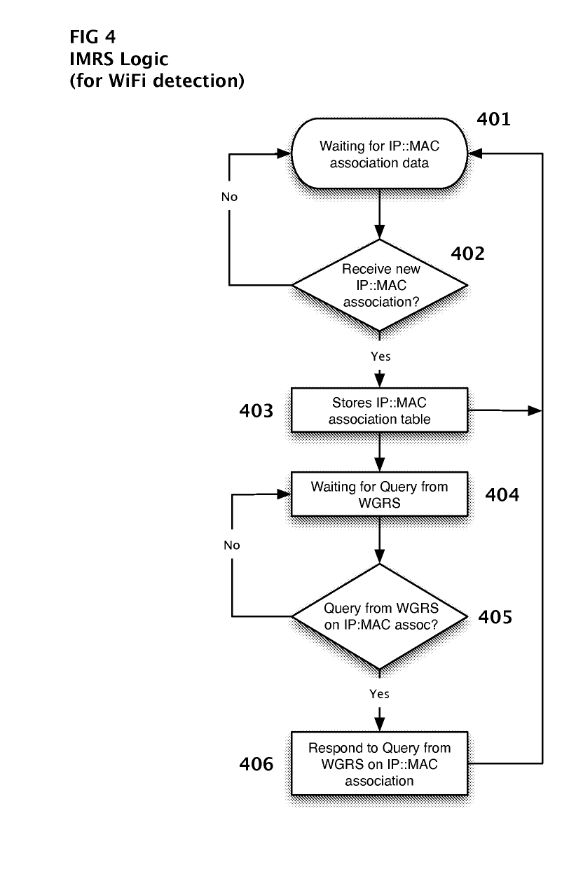

FIG. 5 is the WGRS logic flow diagram in the context of WiFi detection in accordance with one embodiment of the present invention;

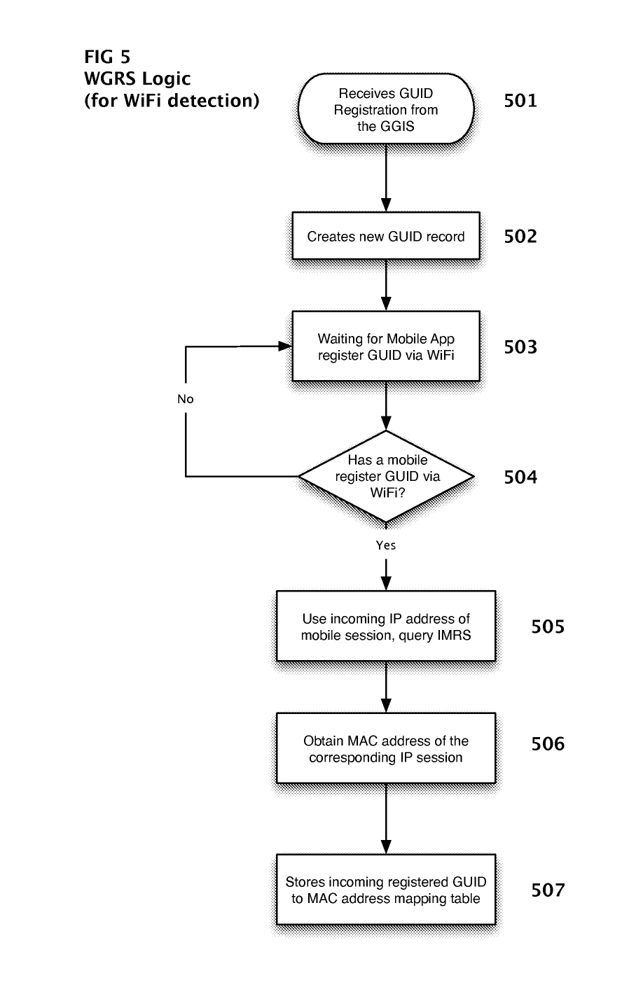

FIG. 6 is the LSD logic flow diagram in the context of WiFi detection in accordance with one embodiment of the present invention;

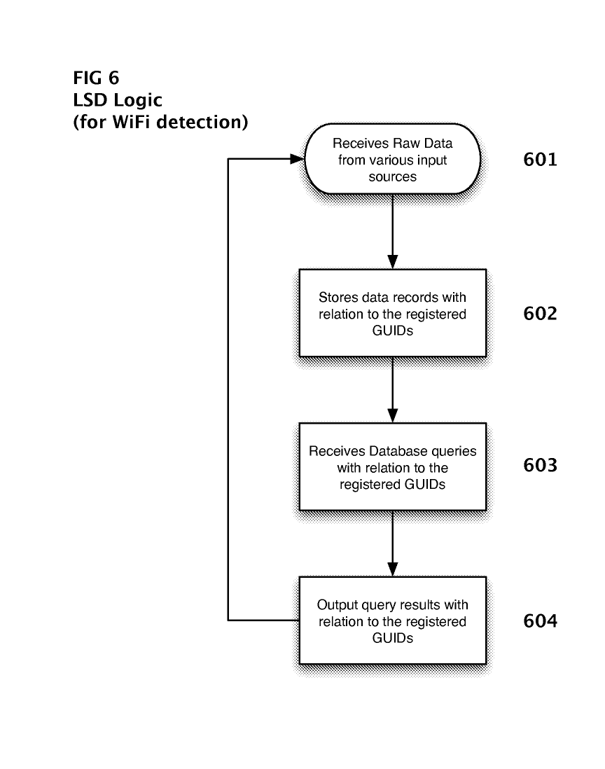

FIG. 7 is the RS logic flow diagram in the context of WiFi detection in accordance with one embodiment of the present invention; and

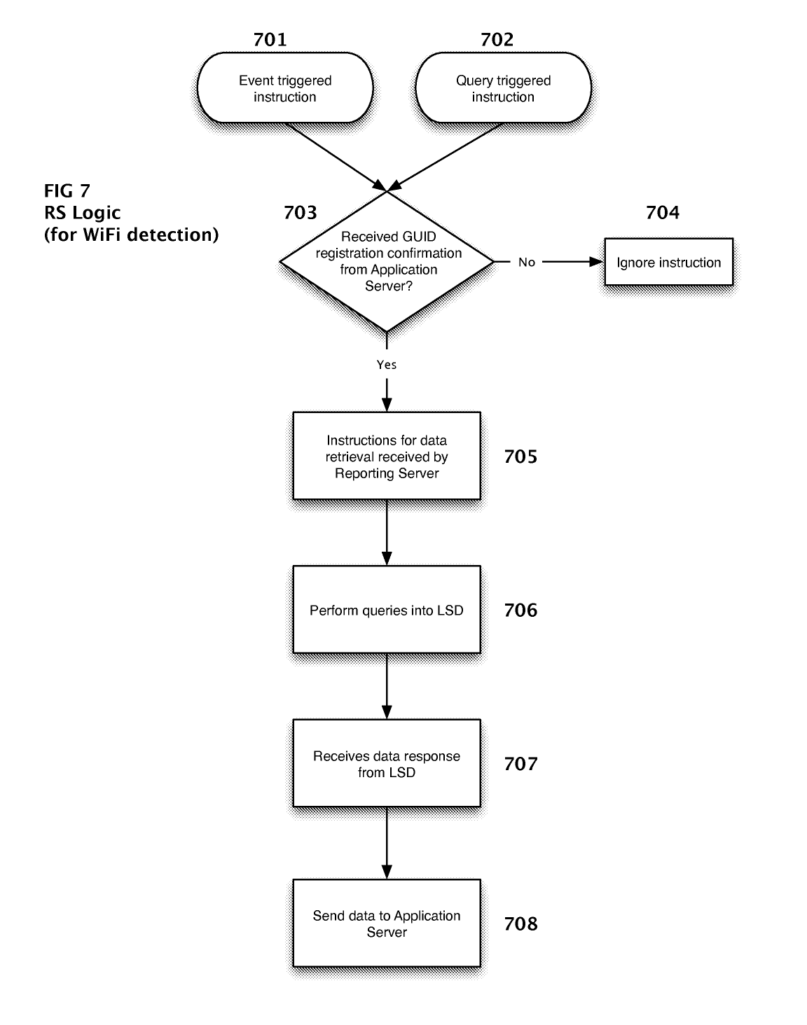

FIG. 8 is the Application Server logic flow diagram in the context of WiFi detection in accordance with one embodiment of the present invention.

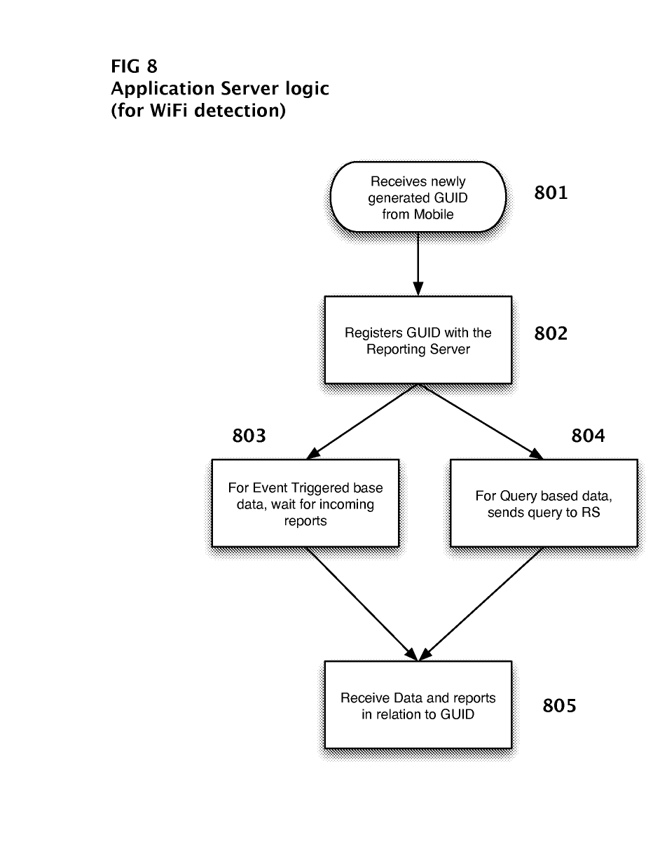

### DEFINITIONS

The following definitions and abbreviations are used in his document for the definitions as stated below:
AP Access Point (WiFi AP)
App Application (Mobile Application)
DHCP Dynamic Host Configuration Protocol
GGIS GUID Generation and Issuance Service
GPS Global Positioning System
GUID Globally Unique Identifier
HTTP/HTTPS HyperText Transfer Protocol/HyperText Transfer Protocol, Secure
ID Identifier
IMRS IP to MAC Record Service
IP Internet Protocol
IOS iPhone Operating System
LSD Lookup Service and Database
MAC Media Access Control address
NAT Network Address Translation
NFC Near Field Communication
OS Operating System
RS Reporting Service
RSSI Received Signal Strength Indication
SELD Sensor Elements Location Database
Smartphone Mobile device that is capable of supporting Mobile Applications
SSID Service Set Identifier
URL Uniform Resource Locator
UUID Universally Unique Identifier
WGRS WiFi GUID Registration Service
WiFi Local area wireless technology
3G/4G 3^{rd} Generation/4^{th} Generation Mobile Networks

### DETAILED DESCRIPTION

Embodiments of the present invention are described herein in the context of a ‘Methodology for detecting smartphone application users utilizing Globally Unique Identifiers and wireless sensors’. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

The term “system” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

Kakku has invented a methodology to detect the location and activities of smartphone application users by combining the use of Globally Unique Identifiers (GUID) and various physical sensor infrastructure technologies. GUID (or UUID) is an acronym for ‘Globally Unique Identifier’ or (‘Universally Unique Identifier’). It is a 128-bit integer number used to identify resources.

There are many use cases in the market that call for the need to perform accurate location base detection of smartphones. There are many technologies currently available in the market that provides means for such detection and tracking.

For example, a method to achieve the objective of detecting mobile devices is by associating device MAC address with IP address and as well as the corresponding HTTP session to enable application acting upon a device MAC address detection. Such method has the following inherent problems:
Only works exclusively under WiFi environment, disregarding other sensor infrastructures such as iBeacon
Device MAC address is considered as user privacy information in some countries and sharing of device MAC address is a breech of user privacy. Workaround to this issue has been implemented by hashing MAC addresses, but the uniqueness of MAC addresses is permanently lost.
Not designed to cater for the fact that users have a range of mobile apps by different application providers on their device, instead of simply using a traditional web browser as the default application
Inability to identify a user in the context of an application, or to notify the user in context of an application while the user's mobile device is in idle-state or sleep mode

This invention utilizes WiFi, iBeacon and NFC technologies to perform the detection of location and activity for smartphone applications, and its users. During the process of such detection, a single constant identifier—the GUID, is used as the anchor, uniquely identifying the Mobile Application on the user smartphone:
GUID is unique to the Mobile Application on a user smartphone that supports the logic stated in this invention
If there are multiple Mobile Applications on the same smartphone that supports the logic stated in this invention, there will be multiple corresponding GUID's attached to each of the Mobile Applications
GUID to Mobile Application effective association will cease once the Mobile Application is uninstalled from the smartphone.
New GUID is regenerated and re-associated on the smartphone should the same Mobile Application is being reinstalled on the user smartphone.

The objective and result of this invention is to:
1. Detect mobile application user locations and activities using a multitude of sensor infrastructure technologies, e.g. WiFi, iBeacon and NFC. Where the sensor network infrastructure maybe provided by a single infrastructure service provider, or a combination of multiple infrastructure service providers
2. Application Providers share and track only one abstracted identifier for each of their mobile application user
3. To accurately, near-real-time, detect location of an application user, when the smartphone is screen-off, idle state. E.g. no active application launch is required.
4. To utilize location information to perform application intelligent actions and policies upon the user
5. To produce analytical information about the historical locations and activities of the mobile application user
6. Creates no impact, or minimal impact on existing smartphone users behavior.

This invention achieves the objectives with collaboration amongst: (1) Mobile Application, (2) Sensor Network Infrastructure, (3) Location Server and (4) Application Server.

Components Description:

(1) Mobile Application

Smartphone Apps [101] or applications as distributed on popular application stores are installed on users phones to perform various utility, fun, social and commerce functions. Smartphone Apps are typically “paired” with an Application Server [105] residing in the Internet, in a server-client type model. User ID of an application determines the profile of the person in relation to the app. through such User ID, intelligent profile about the application user can be retrieved. Without such User ID, no profile about the user can be associated. It is often challenging for application developers to associate their application User ID with a network or sensor infrastructure provided information. In this invention, through association with GUID, the Application Server [105] is able to obtain the association of User level profile information combined with infrastructure provided location and activities information. The logic described in this invention runs as software module within the Mobile App [101].

(2) Network and Sensor Infrastructure [112]

WiFi Infrastructure

WiFi Access Point (AP) [102] holds the key about location information. They system knows where a user is because it knows the location on an AP and the corresponding signal strengths between the AP and the smartphone. The system knows the location on an AP because the address/location data is pre-registered with the application. In the context of this invention, the WiFi infrastructure detects device IP and MAC addresses and reports such detection to the Location Server [113]. This invention utilizes the WiFi infrastructure [102] to inform the Location Server [113], about user devices MAC address and related information, as detected over WiFi infrastructure.

iBeacon Infrastructure

iBeacons [103] are deployed as a sensor infrastructure where individual iBeacons are placed at planned locations. iBeacons are uniquely identified by there UUID, Major ID and Minor ID, as being transmitted over the air via Bluetooth Low Energy to smartphones supporting the same technology. iBeacon UUID+Major ID+Minor ID information is mapped directly to an address location that gets stored in the database [110] of the system. Similar to WiFi, iBeacon also provides ranging information that indicates how far away the user smartphone is from the iBeacon device. When Mobile App [101] is installed on the smartphone, the smartphone is instructed by the Mobile App to listen for the UUID+Major ID+Minor ID of the intended iBeacons [103]. Detection of iBeacons will serve as location indicators for the Mobile App and the user smartphone.

Near Field Communication

NFC tags [104] are distributed to locations or premises where a manual tap from NFC enabled smartphones performs a manual “check-in” to the location, hence triggering related application layer actions via the Mobile App [101]. NFC Tags contain IDs that uniquely identify each tag, whose information is also mapped directly to an address location that gets stored in the database [110] of the system. Detection of NFC tags will serve as location indicators for the Mobile App and the user smartphone.

(3) Location Server [113]

The Location Server maintains a SELD [110] that keeps a record of all WiFi Access Points MAC addresses, iBeacon ID information and NFC Tag ID information, mapped to:
Actual Street Address
Building Name
Floor Number
Shop Number
Space ID

Location information maybe abstracted to other information such as GPS coordinate, which is subsequently used to inform the Application Server where a user is being detected.

The Location Server contains the following main functions:
Sensor Elements Location Database (SELD). [110] This component stores detail records of infrastructure elements: WiFi AP, iBeacon, NFC and their corresponding locations
GUID Generation and Issuance Service (GGIS). [106] This component generates and issues GUID to newly registered Mobile App
WiFi GUID Registration Service (WGRS). [108] This component stores records of all GUID registration, and their corresponding Application Server ID, smartphone MAC address
IP to MAC record Service (IMRS). [107] This component stores records for network issued device IP address to device MAC address association
Lookup Service and Database (LSD). [109] This component performs lookup and store records for all real-time and historical location and activity information that corresponds to each GUID.
Reporting Service (RS). [111] This component performs real-time and historical data reporting to Application Servers [105].

(4) Application Server

The Application Server [105] contains application specific, intelligent, contextual profile information and data about a smartphone user, typically with a unique User ID in identifying the smartphone user. The Application Server is typically ‘paired’ with the Mobile App [101] for various utility, fun, social and commerce functions. Application Server runs logic stated in the invention disclosure in the form of a software module with the server.

The Application Server receives GUID registration information from Mobile App, and shares the GUID information with the Location Server [113].

After sharing GUID with the Location Server, the Application Server is ready to query and receive location and activity information regarding the Application User from the Location Server.

The Application Server may receive from Location Server, location information in the full form address as below:
Street Address
Building Name
Floor Number
Shop Number
Space ID

Or the Application Server may receive an abstracted form of location information such as GPS coordinates with floor and space ID

Functional and Logic Description

Smartphone Mobile App Logic

The Smartphone Mobile App [101] is usually paired with the Application Server [105], serving query and data in a ‘server-client” model.

In this invention, on the Smartphone Mobile App, in addition to the session with the Application Server, it creates sessions with:
1) The GGIS [106], a module function of the Location Server [113]
2) The WGRS [108], a module function of the Location Server [113]

When the Mobile App is first launched [201], it goes through the following logic to obtain a GUID:
1) If GUID is issued by the Mobile App itself [202], the Mobile App stores the GUID locally [204], then sends the GUID together with its own Application username ID to the Application Server, for registering the GUID with the Application Server [206]
2) If GUID is not issued by the Mobile App itself, it checks for connectivity to the internet hosted GUID issuance service
3) If there is connectivity, query GGIS for a uniquely generated GUID [203]
4) Receives the GUID, stores GUID on Mobile App permanently [204]
5) Sends the GUID together with its own Application username ID to the Application Server, for registering the GUID with the Application Server [206]
6) Never repeat the above processes again

After obtaining and storing the GUID, the Mobile App next goes through the logic below:
(1) Mobile App detects if a WiFi connection is active [208]
(2) Mobile App creates the HTTP/HTTPS session towards the WGRS URL. If the URL is reachable:
   a. Mobile App posts its own GUID information to the WGRS [209]
   b. The Mobile App does not perform the above tasks again
(3) If the WGRS URL is not reachable:
   c. Mobile App will continue trying steps (1) and (2) above the next time the Mobile App is launched. [207]

GGIS (Location Server)

The GUID Generation and Issuance Service [106] may reside on one of the following premises:
a) On the Mobile App itself [101]
b) On the Application Server [105]
c) On a dedicated GUID Generation and Issuance server located on an internet reachable URL

The following process occur on the GUID Generation and Issuance Service:
a) Receives a query from a first time launched Mobile App, requesting for a GUID [301]
b) Generates a GUID and responds to the Mobile App query, issuing the GUID to the Mobile App [304]
c) Sends the newly generated GUID to the WGRS, another component of the Location Server. This is to register the GUID with the Location Server. [305]

IMRS (Location Server)

The IP-to-MAC Record Service [107] contains an up-to-date IP address to MAC address association table of the WiFi network. IP addresses are typically issued by the DHCP within a service provider WiFi network, the IP address issued to corresponding device MAC address information is stored in the IP-to-MAC Record Service. The IMRS must have direct IP connectivity to mobile devices via the WiFi network, without NAT function.

This component follows the process below:
(1) Receives IP-to-MAC address mapping information from the WiFi network element(s) [402]
(2) Stores IP-to-MAC address association data [403]
(3) Receives query from WGRS, respond to that query with corresponding MAC address data [405] [406]

WGRS (Location Server)

The WiFi GUID Registration Service [108] keeps a database record of all previously registered GUIDs and their corresponding device MAC addresses. It has the following network data and information about a particular WiFi-associated Mobile App [101]:
GUID associated with the Mobile App
The MAC address of the Smartphone

The WiFi GUID Registration Service follows the logic stated below:
(1) Receives GUID registration from the GUID Generation and Issuance Service [501]
(2) Creates a new record entry for this GUID received [502]
(3) Wait for Mobile App to register GUID via WiFi connection [503]
(4) Receives a GUID registration from the Mobile App via WiFi [504]:
a. Based on incoming source IP address of the Mobile App session, query the IP-to-MAC record service to retrieve the device MAC address [505] [506]
b. Stores to the database GUID to MAC address association [507]

LSD (Location Server)

The SELD [110] is the ‘engine’ of the system. The LSD lookup server [109] collects raw data from various sources [601], perform lookup on raw data collected against SELD records. Raw data maybe formatted or stored as raw into the database in relation to the GUID [602].

Lookup Service responds to queries, returning results and parameters used to report events or analytics to the Application Server [603] [604].

In its basic form, SELD contains records of GUIDs, device MAC addresses and their corresponding locations with timestamps.

The specific implementation of the ‘engine’ is outside the scope of this invention disclosure.

RS (Location Server)

The Reporting Service [111] reports events and data to Application Servers[105] based on (1) Query base reporting [702], (2) Event Triggered base reporting [701].

Query base reporting is demand driven, where the Application Server sends the query to the Reporting Service requesting for certain data and information.

Event Triggered base reporting is push driven, where the Reporting Service pushes the data and the information to the Application Server as soon as a pre-configured event is detected.

GUID is used extensively on the Reporting Service to uniquely identify a user while reporting to the Application Servers.

The Reporting Service follows the tasks below:
(1) Receives GUID registration confirmation from the Application Server [703]
(2) Acknowledges reception of GUID registration back to the Application Server [703]
(3) Only starts reporting events, data and information related to the acknowledged GUID towards the Application Server. [705]
(4) Receives event triggered data, and send such data to the Application Server [705] [707] [708]
(5) Receives demand query from Application Server, perform data retrieval, and send such data to the Application Server [705] [706] [707] [708]

Application Server

The Application Server [105] contains application specific, intelligent, contextual profile information and data about a smartphone user, typically with a unique User ID in identifying the smartphone user. The Application Server is typically ‘paired’ with the Mobile App [101] for various utility, fun, social and commerce functions.

The Application Server interfaces with the Reporting Service [111] (Location Server) with the following tasks:

(1) Via pre-established API, registers a newly received GUID from the Mobile App [801], sends registration confirmation to RS [802]

(2) Via pre-established API, sends Query towards the Reporting Service requesting for specific data and information [802]

(3) Via pre-established API, receives both query based and event triggered base data and information from the Reporting Service (Location Server) [803] [804] [805]

The Application Server interfaces with the Mobile App according to the following logic:

(1) Receives the record of {GUID, Applications User ID} from Mobile App [801]

Mobile Application Location Detection

This disclosure describes the mobile application location detection via the (1) WiFi network infrastructure [102], (2) iBeacon infrastructure [103] and (3) NFC tag infrastructure [104].

WiFi Location Detection

Mobile App [101] location maybe detected using the WiFi infrastructure as per the following:

(1) Smartphone must have its WiFi feature turned on

(2) Smartphone must perform at least one valid WiFi association to register its GUID with the WGRS [108]

(3) Subsequently, smartphone may or may not need to perform valid WiFi association

(4) During WiFi ‘Association mode’, i.e. Smartphone is actively associated with an SSID on the WiFi network, the MAC address of the smartphone is reported to the Location Server [113] by the WiFi Access Points, together with signal strength information such as RSSI

(5) During WiFi ‘Probe mode’, i.e. Smartphone is not actively associated with an SSID on the WiFi network, however the smartphone is broadcasting discovery messages scanning for historically connected SSID. Smartphone MAC address is picked up by the WiFi Access Points, together with signal strength information, and reported to the Location Server.

(6) Location Server performs GUID to MAC address lookup and has the ability to detect the location of the Mobile App and its user

iBeacon Location Detection

Mobile App [101] is programmed to instruct the underlying mobile Operating System (such as Apple IOS and Android OS) to performing listening tasks on Bluetooth Low Energy (BLE) ready to pick up specific iBeacon UUID+Major ID+Minor ID [103] values transmitted by nearby installed iBeacons.

Once the mobile OS picks up a match in the iBeacon identifiers, the Mobile App immediately sends a Location Detection Report to the Location Server [113]. The Location Detection Report message contains: UUID, Major ID, Minor ID, range and GUID

NFC Location Detection

Mobile App [101] is programmed to instruct the underlying mobile Operating System (such as Apple IOS and Android OS) to perform listening tasks on NFC [104], ready to pick up specific NFC Tag ID values transmitted by nearby installed NFC Tags.

Once the mobile OS picks up a match in the NFC Tag identifiers, the Mobile App immediately sends a Location Detection Report to the Location Server. The Location Detection Report message contains: NFC Tag ID and GUID

Multichannel Detection and Multi-Server Reporting

There is a possibility the same Mobile App is detected by more than one sensor infrastructure at the same location.

There is also a possibility there are multiple Mobile Apps on the same smartphone being detected at a location.

In the event where the same Mobile App is detected by more than one sensor infrastructure at the same location:

1. The LSD [109] and RS [111] may perform policy functions in the Location Server ensuring any overlap detection and location reporting is eliminated. This results in only single {GUID, Location} report for such instance.

2. The LSD and RS may perform policy functions to continue reporting multiple detection and location reports due to the granularity and accuracy of each sensor infrastructure. For instance, a WiFi detection range is larger versus an NFC manual tap base detection, one captures users without the intent in the approximate area, while the other captures users with strong intent in specific accurate location. This results in multiple (GUID, Location, Accuracy} reports for such instance, where the GUID is identical for each report.

In the event where there are multiple Mobile Apps on the same smartphone being detected at a location:

(1) Each individual Mobile App [101] has its own corresponding GUID

(2) Each Mobile App on the same device reports their own {Location ID, GUID} set to the Location Server [113]

(3) Location Server reports to each Application Servers [105] in which the Mobile Apps are associated with, their corresponding set of {GUID, Location} information.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method comprising detecting the location of smartphone application users by combining the use of Globally Unique Identifiers (GUID) and physical sensor infrastructure technologies WiFi, iBeacon and NFC.

2. The method of claim 1, wherein a single constant identifier—the GUID, is used as the anchor, uniquely identifying the Mobile Application on the user smartphone:
a. GUID is unique to the specific Mobile Application on a user smartphone that supports the logic stated in this invention.

3. The method of claim 1, wherein if there are multiple Mobile Applications on the same smartphone that supports the logic stated in this invention, there will be multiple corresponding GUID's attached to each of the Mobile Applications.

4. The method of claim 1, wherein the GUID to a Mobile Application effective association will cease once the Mobile Application is uninstalled from that smartphone.

5. The method of claim 1, wherein a new GUID is regenerated and re-associated on the smartphone should the same Mobile Application be reinstalled on the user smartphone.

6. The method of claim 1, wherein through association with GUID, the Application Server can obtain the association of User level profile information combined with infrastructure provided location and activities information.

7. A network system, comprising: Smartphones [101], WiFi infrastructure [102], iBeacon sensor infrastructure [103], NFC sensor infrastructure [104], Location servers [113] and Application server [105], interoperable as a single end-to-end service entity to detect and report on user application locations.

8. The network system of claim 7, further comprising WiFi infrastructure informs the Location Server, about user devices MAC address and related information, as detected over WiFi infrastructure.

9. The network system of claim 7, further comprising within the iBeacons infrastructure, when the Mobile Application is installed on the smartphone, the smartphone is instructed by the Mobile Application to listen for the UUID+Major ID+Minor ID of the intended iBeacons. Detection of iBeacons will serve as location indicators for the Mobile Application and the user smartphone.

10. The network system of claim 7, further comprising within the NFC infrastructure, NFC Tags contain IDs that uniquely identify each tag, whose information is also mapped directly to an address location that gets stored in the database of the system. Detection of NFC tags will serve as location indicators for the Mobile App and the user smartphone.

11. The network system of claim 7, further comprising the Location Server that maintains a SELD that keeps a record of all WiFi Access Points MAC addresses, iBeacon ID information and NFC Tag ID information, mapped to:
a. Actual Street Address, Building Name, Floor Number, Shop Number and Space ID.

12. In the network system of claim 7, wherein location information maybe abstracted to other information such as GPS coordinate, which is subsequently used to inform the Application Server where a user is being detected.

13. In the network system of claim 7, further comprising the Location Server that contains the following main functions:
a. Sensor Elements Location Database (SELD). This component stores detail records of infrastructure elements: WiFi AP, iBeacon, NFC and their corresponding locations.
b. GUID Generation and Issuance Service (GGIS). This component generates and issues GUID to newly registered Mobile Application
c. WiFi GUID Registration Service (WGRS). This component stores records of all GUID registration, and their corresponding Application Server ID, smartphone MAC address.
d. IP to MAC record Service (IMRS). This component stores records for network issued device IP address to device MAC address association.
e. Lookup Service and Database (LSD). This component performs lookup and store records for all real-time and historical location and activity information that corresponds to each GUID.
f. Reporting Service (RS). This component performs real-time and historical data reporting to Application Servers.

14. The method of claim 1, wherein the Application Server receives GUID registration information from Mobile Application, and shares the GUID information with the Location Server.
a. After sharing GUID with the Location Server, the Application Server is ready to query and receive location and activity information regarding the Application User from the Location Server.
b. The Application Server may receive from Location Server, location information in the full form address as below:
i. Street Address, Building Name, Floor Number, Shop Number and Space ID.
c. Or the Application Server may receive an abstracted form of location information such as GPS coordinates with floor and space ID.

15. The method of claim 1, wherein on the Smartphone Mobile App, in addition to the session with the Application Server, it creates sessions with:
a. The GGIS, a module function of the Location Server.
b. The WGRS, a module function of the Location Server.

16. The method of claim 1, wherein the Mobile App is first launched, it goes through the following logic to obtain a GUID:
a. If GUID is issued by the Mobile App itself, receives and store the GUID locally.
b. If GUID is not issued by the Mobile App itself, it checks for connectivity to the internet hosted GUID issuance service.
c. If there is connectivity, query GGIS for a uniquely generated GUID.
d. Receives the GUID, stores GUID on Mobile App permanently.
e. Sends the GUID together with its own Application username ID to the Application Server, for registering the GUID with the Application Server.
f. Never repeat the above processes again.

17. The method of claim 1, wherein after obtaining and storing the GUID, the Mobile App next goes through the logic below:
a. Mobile App detects if a WiFi connection is active.
b. Mobile App creates the HTTP/HTTPS session towards the WGRS URL. If the URL is reachable:
c. Mobile App posts its own GUID information to the WGRS.
d. The Mobile App does not perform the above tasks again.
e. If the WGRS URL is not reachable:
i. Mobile App will continue trying steps (a) and (b) above the next time the Mobile App is launched.

18. The method of claim 1, wherein the GUID Generation and Issuance Service may reside on one of the following premises:
a. On the Mobile App itself.
b. On the Application Server.
c. On a dedicated GUID Generation and Issuance server located on an Internet reachable URL.

19. The method of claim 1, wherein the following process occur on the GUID Generation and Issuance Service:
a. Receives a query from a first time launched Mobile App, requesting for a GUID.
b. Generates a GUID and responds to the Mobile App query, issuing the GUID to the Mobile App.
c. Sends the newly generated GUID to the WGRS, another component of the Location Server. This is to register the GUID with the Location Server.

20. The network system of claim 7, further comprising the IMRS component (IP-to MAC Record Service, located on the Location Server) follows the process below:
a. Receives IP-to-MAC address mapping information from the WiFi network element(s).
b. Stores IP-to-MAC address association data.
c. Receives query from WGRS, respond to that query with corresponding MAC address data.

21. The method of claim 1, wherein the WGRS (WiFi GUID Registration Service, located on the Location Server) has the following network data and information about a particular WiFi-associated Mobile App:
a. GUID associated with the Mobile App.
b. The MAC address of the Smartphone.

22. The method of claim 1, wherein the WGRS follows the logic stated below:
a. Receives GUID registration from the GUID Generation and Issuance Service.
b. Creates a new record entry for this GUID received.
c. Wait for Mobile App to register GUID via WiFi connection.
d. Receives a GUID registration from the Mobile App via WiFi.
e. Based on incoming source IP address of the Mobile App session, query the IP-to-MAC record service to retrieve the device MAC address.
f. Stores to the database GUID to MAC address association.

23. The network system of claim 7, further comprising the RS (Reporting Service, located on Location Server) reports events and data to Application Servers based on (1) Query base reporting, (2) Event Triggered base reporting.

24. The method of claim 1, wherein query base reporting is demand driven, where the Application Server sends the query to the Reporting Service requesting for certain data and information. Event Triggered base reporting is push driven, where the Reporting Service pushes the data and the information to the Application Server as soon as a pre-configured event is detected. Reporting Service follows the tasks below:
a. Receives GUID registration confirmation from the Application Server.
b. Acknowledges reception of GUID registration back to the Application Server.
c. Only starts reporting events, data and information related to the acknowledged GUID towards the Application Server.

25. The method of claim 1, wherein Application Server interfaces with the Reporting Service (Location Server) with the following tasks:
a. Via pre-established API, registers a newly received GUID from the Mobile App.
b. Via pre-established API, sends Query towards the Reporting Service requesting for specific data and information.
c. Via pre-established API, receives both query based and event triggered base data and information from the Reporting Service (Location Server).

26. The method of claim 1, wherein the Application Server interfaces with the Mobile App according to the following logic:
a. Receives the record of {GUID, Applications User ID} from Mobile App.

27. The method of claim 1, wherein the Mobile App location maybe detected using the WiFi infrastructure as per the following:
a. Smartphone must have its WiFi feature turned on.
b. Smartphone must perform at least one valid WiFi association to register its GUID with the WGRS.
c. Subsequently, smartphone may or may not need to perform valid WiFi association.
d. During WiFi ‘Association mode’, i.e. Smartphone is actively associated with an SSID on the WiFi network, the MAC address of the smartphone is reported to the Location Server by the WiFi Access Points, together with signal strength information such as RSSI.
e. During WiFi ‘Probe mode’, i.e. Smartphone is not actively associated with an SSID on the WiFi network, however the smartphone is broadcasting discovery messages scanning for historically connected SSID. Smartphone MAC address is picked up by the WiFi Access Points, together with signal strength information, and reported to the Location Server.
f. Location Server performs GUID to MAC address lookup and has the ability to detect the location of the Mobile App and its user.

28. The method of claim 1, wherein the Mobile app location may be detected by iBeacon, once the mobile OS picks up a match in the iBeacon identifiers, the Mobile App immediately sends a Location Detection Report to the Location Server. The Location Detection Report message contains: UUID, Major ID, Minor ID, range and GUID.

29. The method of claim 1, wherein the Mobile app location may be detected by NFC, the mobile OS picks up a match in the NFC Tag identifiers, the Mobile App immediately sends a Location Detection Report to the Location Server. The Location Detection Report message contains: NFC Tag ID and GUID.

30. The method of claim 1, wherein the event where the same Mobile App is detected by more than one sensor infrastructure at the same location:
a. The LSD and RS may perform policy functions in the Location Server ensuring any overlap detection and location reporting is eliminated. This results in only single {GUID, Location} report for such instance.
b. The LSD and RS may perform policy functions to continue reporting multiple detection and location reports due to the granularity and accuracy of each sensor infrastructure. For instance, a WiFi detection range is larger versus an NFC manual tap base detection, one captures users without the intent in the approximate area, while the other captures users with strong intent in specific accurate location. This results in multiple (GUID, Location, Accuracy} reports for such instance, where the GUID is identical for each report.

31. The method of claim 1, wherein the event where there are multiple Mobile Apps on the same smartphone being detected at a location:
a. Each individual Mobile App has its own corresponding GUID.
b. Each Mobile App on the same device reports their own {Location ID, GUID} set to the Location Server.
c. Location Server reports to each Application Servers in which the Mobile Apps are associated with, their corresponding set of {GUID, Location} information.
